(19) United States
(12) Patent Application Publication
(10) Pub. No.: US 2016/0121611 A1
(43) Pub. Date: May 5, 2016

(54) PIEZO-ACTUATED INKJET PRINT HEAD, METHOD OF DESIGNING SUCH A PRINT HEAD AND A METHOD OF MANUFACTURING SUCH A PRINT HEAD

(71) Applicant: OCE-TECHNOLOGIES B.V., Venlo (NL)

(72) Inventors: Hans REINTEN, Velden (NL); Hendrik J. STOLK, Bergen (NL); Patrick H.M.A. BRANDTS, Maastricht (NL)

(73) Assignee: OCE-TECHNOLOGIES B.V., Venlo (NL)

(21) Appl. No.: 14/991,430

(22) Filed: Jan. 8, 2016

Related U.S. Application Data
(63) Continuation of application No. PCT/EP2014/065230, filed on Jul. 16, 2014.

(30) Foreign Application Priority Data
Jul. 23, 2013 (EP) 13177581.9

(51) Int. Cl. B41J 2/14; B41J 2/16

(52) U.S. Cl. CPC B41J 2/14274; B41J 2/1612

(57) ABSTRACT

An inkjet print head for expelling a droplet of a fluid through a nozzle orifice comprises a fluid channel for holding a channel amount of fluid, the fluid channel comprising a pressure chamber in fluid communication with the nozzle orifice and a piezo actuator. The piezo actuator comprises an active piezo stack, which stack comprises a first electrode, a second electrode, and a piezo-material layer arranged between the first and the second electrode, and the piezo actuator comprises a membrane having a first side and a second side, the second side being opposite to the first side. The active piezo stack is provided at the first side and the pressure chamber at the second side such that the membrane forms a flexible wall of the pressure chamber. The fluid channel, when holding the channel amount of fluid, has a fluid compliance and the piezo actuator has an actuator compliance. In accordance with the present invention, the actuator compliance is larger than the fluid channel compliance such to have a high energy coupling efficiency and consequently a low power dissipation.

### FIELD OF THE INVENTION

The present invention generally pertains to a piezo-actuated inkjet print head, a method of designing such a print head and a method for testing such a print head, wherein the print head is provided with a piezo actuator arranged for generating a pressure wave in a liquid in a pressure chamber such to expel a droplet of the liquid through a nozzle orifice.

### BACKGROUND ART

Inkjet print heads for generating and expelling droplets of fluid are well known in the art. A number of actuation methods are known to be employed in such print heads. In a known inkjet print head, a piezo stack, comprising a first electrode, a second electrode and a piezo-material layer therebetween, is driven to deform a flexible wall of a pressure chamber such that a pressure wave is generated in a fluid present in the pressure chamber. The pressure chamber is in fluid communication with a nozzle orifice of the print head and the pressure wave is such that a droplet of the fluid is expelled through the nozzle orifice.

In order to actuate, a drive voltage is applied to the piezo stack, which piezo stack acts as a capacitor. Suitable drive circuitry supplies an actuation voltage and corresponding current. In order to generate and supply such drive voltage and current, power is consumed and heat is generated in the drive circuitry. In present inkjet print heads made using semiconductor technology (micro electromechanical systems (MEMS) technology) a high density arrangement of nozzle orifices and corresponding actuators is obtainable. However, in such high density arrangements and operating at a high frequency, a relatively large amount of heat is generated in the drive circuitry, including in any electrodes in the inkjet print head. A density of an arrangement of electrodes and a cross-section of each electrode (determining an electrical resistance in the electrodes) becomes limited due to which the design of such print heads. Further, due to heat generation in the voltage generating circuitry, incorporating the voltage generating circuitry in the inkjet print head is not feasible.

It is advantageous to have a print head design in which a relatively low amount of heat is generated.

### SUMMARY OF THE INVENTION

In an aspect of the present invention, an inkjet print head is provided. The inkjet print head comprises a fluid channel for holding a channel amount of fluid. The fluid channel comprises a pressure chamber in fluid communication with the nozzle orifice. The inkjet print head further comprises a piezo actuator. The piezo actuator comprises an active piezo stack and a membrane. The active piezo stack comprises a first electrode, a second electrode, and a piezo-material layer arranged between the first and the second electrode. The membrane has a first side and a second side, the second side being opposite to the first side. The active piezo stack is provided at the first side and the pressure chamber at the second side such that the membrane forms a flexible wall of the pressure chamber.

The fluid channel, when holding the channel amount of fluid, has a fluid channel compliance and the piezo actuator has an actuator compliance. The fluid channel compliance has a number of contributions, inter alia from a compliance resulting from the amount of fluid present and a compliance resulting from the print head structure, including the compliance of the materials used. It is noted that the actuator compliance is not included in the fluid channel compliance; adding the actuator compliance and the fluid channel compliance results in a total system compliance or, in other words, the fluid channel compliance corresponds to the total system compliance minus the actuator compliance. In accordance with the present invention, the actuator compliance is larger than the fluid channel compliance. Preferably, the actuator compliance is significantly—e.g. 2, 3, 5, 10 or even more times—larger than the fluid channel compliance.

JP2004-017612 discloses a piezo-actuated inkjet print head wherein a compliance of the vibrating plate is made larger than a compliance of a fluid filled in a pressure generating chamber. The teaching of the disclosure relates to merely controlling the Helmholtz frequency of the system and ignores a compliance of the total inkjet print head system by not taking into account e.g. a compliance of the structural features of the print head. The present invention takes into account all compliances—the fluid channel compliance being defined by the fluid channel compliance and the actuator compliance together forming the total system compliance—in order to obtain an energy efficient system.

An acoustic design of a piezo-actuated inkjet print head is inter alia defined by an unloaded volume displacement of the actuator in response to a drive voltage and by the total system compliance. Such acoustic design determines the droplet generation, including a droplet generation frequency. When designing an inkjet print head and starting from print head requirements, an acoustic design may be selected. Then, in order to optimize an energy consumption without affecting the acoustic design, a ratio between the fluid channel compliance and the actuator compliance may be selected, provided that the total system compliance fits the acoustic design. As is described in more detail hereinbelow in relation to FIG. 2, an energy coupling coefficient indicating an energy efficiency of the print head acoustics, i.e. the droplet forming process, compared to the electrical energy input, is defined by

$${ECC}_{acoustics} = {k}^{2} \frac{{B}_{act}}{{B}_{act} + {B}_{chan}} \qquad ( Eq . 1 )$$

Energy efficiency is improved if the energy coupling coefficient ECC is increased. Based on Eq. 1, it is apparent that the energy coupling coefficient ECC_{acoustics} of the print head acoustics is increased when the actuator compliance B_{act} is selected to be higher than the fluid channel compliance B_{chan}. The term k² is an actuator energy coupling coefficient that has a certain optimal value. Based on such optimal value, the actuator compliance B_{act} may be deemed defined. Therefore, in practice, it may be considered that designing the inkjet print head to have a relatively low fluid channel compliance compared to the actuator compliance is a well suited method for improving the energy efficiency. Using a relatively low fluid channel compliance, an energy coupling coefficient will be relatively high and consequently, an overall energy efficiency of the print head is improved. As a consequence, a low driving voltage/low current may be used for driving the print head and thus power dissipation in the drive circuitry is decreased. A method of designing a piezo-actuated inkjet print head having a fluid channel compliance significantly lower than an actuator compliance is another aspect of the present invention.

As the actuator compliance is—in accordance with the present invention—a major contributor in the total system compliance, which has a significant contribution in defining the print head design, the actuator compliance is an important aspect to be accurately realized in an actual print head. In practice, a manufacturing accuracy of a large number of features influences the resulting actuator compliance and defining manufacturing tolerances for each of such features may result in very strict tolerances that increase the costs for the print head manufacturing or would even prohibit manufacturing as such strict tolerances may not be realistic. Therefore, it may be desirable to manufacture the inkjet print heads in large quantities using not so strict tolerances. Then, the actuator compliance of the resulting print heads may be determined. In many instances the inaccuracies in the manufacturing compensate each other resulting in a sufficient number of print heads meeting the requirements on actuator compliance. Discarding of the print heads that do not have an actuator compliance within a desired actuator compliance range may thus be more cost effective and realistic than posing very strict manufacturing accuracies. Moreover, for certain applications, a deviation from the originally defined compliance may be acceptable and a number of print heads having an actuator compliance deviating from the specified actuator compliance may be used for such applications, e.g. sorted based on their actual actuator compliance. In another embodiment, the actual actuator compliance may be compensated by an adapted drive voltage pulse. So, the determined actual compliance may be used to determine the adapted actuator voltage pulse.

In such a manufacturing method, it is desired to have a simple and cost effective method of determining the actual actuator compliance. Therefore, in a further aspect, the present invention provides a method of testing a piezo-actuated print head for an actuator compliance and preferably also other actuator properties. The method includes the steps of performing impedance spectroscopy to determine an actuator impedance spectrum. Based on the impedance spectrum, an actual actuator compliance is derived. Then, the actual actuator compliance may be compared with a desired actuator compliance.

Of course, such testing can be performed on only a part of the print head to be manufactured, if such a part comprises all elements needed to determine an impedance spectrum suitable for deriving the actuator compliance. So, at least the piezo-actuator comprising the active piezo-stack and the membrane needs to be comprised in such part of the print head. In this practical embodiment, if the actuator compliance is not within the desired actuator compliance range, only a part of the print head needs to be discarded instead of a whole print head.

Based on the results of the testing of manufactured inkjet print heads, if too many print heads do not have an actuator in accordance with the desired specification of the actuator compliance, the manufacturing process parameters of one of the aspects affecting the actuator compliance may be adapted without determining which aspect actually deviates from the design. For example, if the actuator compliance is not within the desired actuator compliance range, a membrane thickness may be adapted such to adapt the actuator compliance without first determining why the actuator compliance is actually outside the desired actuator compliance range.

Further scope of applicability of the present invention will become apparent from the detailed description given hereinafter. However, it should be understood that the detailed description and specific examples, while indicating embodiments of the invention, are given by way of illustration only, since various changes and modifications within the scope of the invention will become apparent to those skilled in the art from this detailed description.

### BRIEF DESCRIPTION OF THE DRAWINGS

The present invention will become more fully understood from the detailed description given hereinbelow and the accompanying schematical drawings which are given by way of illustration only, and thus are not limitative of the present invention, and wherein:

FIG. 1 schematically illustrates an exemplary design of a piezo-actuated inkjet print head;

FIG. 2 illustrates a piezo-actuator as used in the print head according to FIG. 1; and

FIG. 3 shows a graph of an effect of the ratio between actuator compliance and fluid channel compliance; and

FIG. 4 shows a graph of an impedance spectrum obtained from a print head according to FIG. 1.

### DETAILED DESCRIPTION OF THE DRAWINGS

The present invention will now be described with reference to the accompanying drawings, wherein the same reference numerals have been used to identify the same or similar elements throughout the several views.

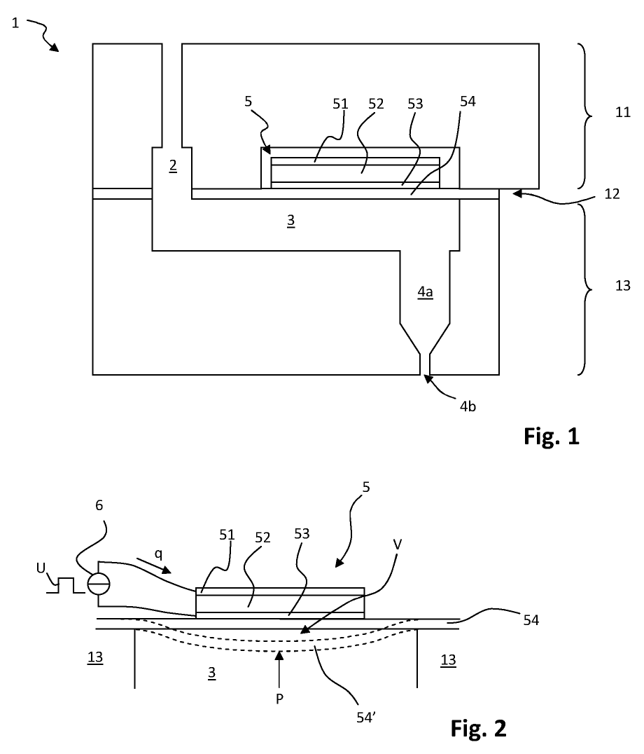

FIG. 1 shows an example of a design of a piezo-actuated inkjet print head 1. The inkjet print head 1 is formed by a three layered structure having a supply layer 11, a membrane layer 12 and an output layer 13. A fluid channel is composed of a supply channel 2, a pressure chamber 3, an output channel 4a and a nozzle orifice 4b. The membrane layer 12 comprises a piezo actuator 5. The piezo actuator is formed by a first electrode 51, a piezo material layer 52, a second electrode 53 and a membrane 54. The first electrode 51, the second electrode 53 and the piezo material layer 52 arranged therebetween together form the active piezo stack. Upon application of a voltage over the first electrode 51 and the second electrode 53, an electrical field is provided in the piezo material layer 52 and as a consequence the piezo material layer 52 contracts or expands, in the present embodiment in a direction parallel to the membrane 54. As the piezo material layer 52 is adhered to first electrode 51 and the second electrode 53 and indirectly to the membrane 54 and as at least the membrane 54 counteracts such contraction or expansion, the piezo actuator 5 deforms by bending as illustrated in and described in relation to FIG. 2 hereinbelow.

An actuation of the actuator generates a pressure wave in a fluid present in the fluid channel. The actuation and following pressure wave eventually induces a deformation of the piezo actuator 5 and a corresponding volume change in the fluid channel, in particular in the pressure chamber 3. Thus, a suitably designed print head and a suitably generated pressure wave will result in a droplet being expelled through the nozzle orifice 4b, as is well known in the art.

The supply layer 11 and the output layer 13 of the inkjet print head 1 may be formed from silicon wafers. The fluid channel may be formed in such silicon wafers by well known etching methods, for example. Using silicon wafers and etching techniques allows to generate relatively small structures such that a high density arrangement of nozzle orifices 4b may be obtained. Thus, it may be possible to manufacture an inkjet print head 1 having a nozzle arrangement of 600 or even 1200 nozzles per inch (npi) that may be used in a printer assembly for printing at 600 or 1200 dots per inch (dpi), respectively. In a high density arrangement of nozzle orifices 4b, there is of course also a high density of corresponding piezo actuators 5. When operating the inkjet print head 1 drive circuitry generates an amount of heat due to power dissipation. For freedom of design, the power dissipation should be kept to a minimum. Therefore, a high energy efficiency is needed. A high energy efficiency may be achieved by obtaining a high energy coupling coefficient, i.e. a coefficient indicating a ratio of energy effectively used and energy input into the system.

In the field of piezo actuated inkjet print heads, an energy coupling coefficient of the electrical energy input and the energy effectively applied to the fluid, i.e. the acoustic energy, should be maximized for obtaining a high energy efficiency. Suitably designing the inkjet print head 1 enables to obtain a high energy coupling coefficient.

FIG. 2 shows the actuator 5 of the inkjet print head 1 of FIG. 1 in more detail. A drive voltage source 6 is connected between the first electrode 51 and the second electrode 53. The drive voltage source 6 is configured for supplying a drive voltage U. The active piezo stack functions as a capacitor and consequently an electrical charge q will be supplied to the piezo actuator 5 upon supply of the drive voltage U. Due to the piezo properties of the piezo material layer 52 in response to the electrical field between the first electrode 51 and the second electrode 53, the actuator 5 will deform resulting in a shape of the membrane 54′ (dashed). It is noted that the active piezo stack will of course deform to and remain on the membrane 54, but for clarity reasons the deformed active piezo stack is omitted in FIG. 2. Due to the deformation, a volume change V results in the pressure chamber 3. The fluid in the pressure chamber 3 exerts a pressure P.

Based on the above described and in FIG. 2 illustrated structure and operation, a mathematical model describing the operation of the actuator may be defined:

$$( \begin{matrix}V \\ q\end{matrix} ) = [ \begin{matrix}{A}_{act} & - {B}_{act} \\ {C}_{act} & - {A}_{act}\end{matrix} ] ( \begin{matrix}U \\ p\end{matrix} )$$

in which A is a volume displacement per volt of the actuator, B is the actuator compliance and C is the electrical capacitance of the actuator. Based on the model as described by Eq. 2, an actuator energy coupling coefficient may be derived to be equal to:

$${k}_{act}^{2} = \frac{{A}_{act}^{2}}{{B}_{act} \cdot {C}_{act}} \qquad ( Eq . 3 )$$

It is noted that A_{act}, B_{act} and C_{act} are not independent variables. Changing the actuator compliance B_{act} will affect the volume displacement A_{act}, for example. So, in practice, it has appeared that changing the parameters of the actuator 5 within practical boundaries will not significantly affect the actuator energy coupling coefficient k². Thus, a suitably designed actuator may be presumed to have a certain actuator energy coupling coefficient k². Therefore, hereafter, the actuator energy coupling coefficient k² is presumed to be a constant for the piezo actuated inkjet print head 1.

Considering the mathematical model of the actuator 5 and taking into account the print head 1 as a whole, an acoustic energy coupling coefficient ECC_{acoustics} describing the coupling between the electrical energy input and the effective acoustic energy is derivable:

$${ECC}_{acoustics} = {k}^{2} \frac{{B}_{act}}{{B}_{act} + {B}_{chan}} \qquad ( Eq . 1 )$$

in which B_{chan} is the compliance of the fluid channel. Taking k² as a constant as above explained, the ratio of the actuator compliance B_{act} over the total system compliance, i.e. the sum of the actuator compliance B_{act} and the fluid channel compliance B_{chan}, determines the resulting acoustic energy coupling coefficient ECC_{acoustics}. In general, the conclusion is to select the actuator compliance B_{act} to be larger, preferably two times or even five times larger than the fluid channel compliance B_{chan}. In such embodiment, the ratio increases and hence the acoustic energy coupling coefficient ECC_{acoustics} is maximized.

In practical situations, when designing the inkjet print head 1 and in view of controlling actuator properties, the above conclusion may be realized by adapting the fluid channel compliance B_{chan} after the actuator compliance B_{act} has been determined and selected. Although adapting the actuator compliance may be suitable, it is noted that a change of the actuator compliance B_{act} may more impact on other aspects of the print head design. Adapting the fluid channel compliance B_{chan} may be achieved by adapting dimensions of the pressure chamber 3 considering that the fluid channel compliance B_{chan} has a large contribution from the compliance of the liquid present in the pressure chamber 3. While the length and width of the pressure chamber 3, i.e. the dimensions parallel to the membrane 54, have a direct relation to a membrane surface area and thus to the acoustic inkjet print head design, which should not be changed significantly to prevent changes in the acoustic design, the compliance of the liquid in the pressure chamber 3 is easily and effectively adapted by changing a depth, i.e. a dimension perpendicular to the membrane 54, of the pressure chamber 3. However, it is noted that other dimensions may be adapted such to change the fluid channel compliance, although in such case usually multiple dimensions need to be adapted to maintain the original acoustic design.

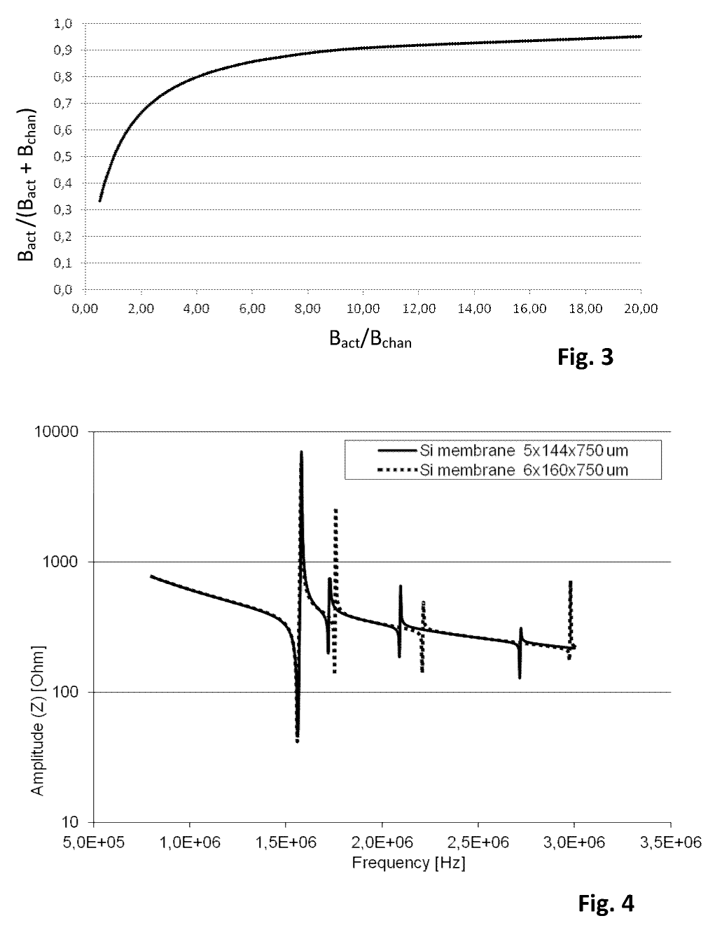

FIG. 3 shows a graph that illustrates the influence of the ratio between the actuator compliance and the total compliance on the energy efficiency of the inkjet print head. The horizontal axis of the graph represents the ratio of the actuator compliance and the fluid channel compliance. The vertical axis represents the ratio of the actuator compliance and the total system compliance, which is a factor in the energy coupling coefficient as indicated in Eq. 1. This factor should be selected to be high. As is apparent from this graph, when the actuator compliance is lower than the fluid channel compliance, the ratio of the actuator compliance and the total system compliance is smaller than 0.5 and when the actuator compliance is equal to the fluid channel compliance, the ratio of the actuator compliance and the total system compliance is 0.5. Selecting the actuator compliance to be twice as large as the fluid channel compliance, the ratio between the actuator compliance and the total system compliance increases to 0.67, which amounts to an energy coupling coefficient improvement of 33% compared to the case where the actuator compliance and the fluid channel compliance are equal. In practice, it is feasible to select an actuator compliance to be as large as five times the fluid channel compliance—improvement of 67% compared to the case where the actuator compliance and the fluid channel compliance are equal—or even 10 times the fluid channel compliance—improvement of 82% compared to the case where the actuator compliance and the fluid channel compliance are equal. It is noted however that the sensitivity to deviations in the actuator compliance due to manufacturing tolerances becomes higher with increasing ratio of the actuator compliance and the fluid channel compliance, while the improvement of the energy coupling coefficient becomes minor. For example, a ratio of the actuator compliance over the fluid channel compliance of 10 results in an improvement of only 9% as compared to a ratio of 5. So, in practice, a ratio of the actuator compliance over the fluid channel compliance may be effectively selected to be in range of about 2 to about 10 and preferably in a range of about 3 to about 5.

As the actuator compliance B_{act} is relatively large and thus has a strong impact on the operation of an actual inkjet print head if the actual actuator compliance B_{act} deviates from a designed and desired actuator compliance B′_{act} it is desired to be able to accurately control the manufacturing of the inkjet print head, in particular the actuator 5. However, it has appeared that taking into account all potentially relevant features and their manufacturing tolerances it may be difficult and costly to have a suitable manufacturing method. Moreover, in many instances, the inaccuracies in manufacturing may, in practice, compensate each other. Therefore, manufacturing the actuator 5 in accordance with common and cost-effective methods and verifying the resulting actuator compliance B_{act} is a suitable method for manufacturing.

A method of manufacturing an inkjet print head in accordance with the present invention thus includes determining the actuator compliance B_{act}. The step of determining the actuator compliance B_{act} includes a step of performing impedance spectroscopy on a relevant part of the piezo-actuated inkjet print head to obtain an impedance spectrum of the actuator; and deriving from the impedance spectrum the actual actuator compliance. The actual actuator compliance may then be compared to the desired actuator compliance. It is noted that the impedance spectroscopy is a simple electrical measurement on the actuator. So, the measurement may be performed even before the actuator is adhered to other parts of the print head, depending on the specific method of manufacturing the print head.

FIG. 4 illustrates two exemplary graphs of such an impedance spectrum. It is remarked that the illustrated impedance spectra result from a mathematical simulation. A first graph is shown with a solid line and relates to a piezo actuator having a membrane that is 5 micron in thickness, has an effective length of 750 micron and an effective width of 144 micron. A second graph is shown with a dashed line and relates to a piezo actuator having a membrane that is 6 micron in thickness, has an effective length of 750 micron and an effective width of 160 micron. The effective length and the effective width of the membrane are the length and width used in the mathematical model to represent the flexible wall part of the membrane, i.e. the functional part of the membrane. In practice, the actual length and width may be slightly different depending on, amongst other aspects, the stiffness of the clamping of the membrane between the supply layer and the output layer. For example, if a relatively thick layer of adhesive would be used for joining the supply layer, the membrane layer and the output layer, such adhesive might be flexible such that the membrane may bend beyond a boundary of the pressure chamber. In such an example, the effective length and the effective width may be larger than the actual length and the actual width of the pressure chamber, respectively. Based on the graph, it is apparent that the membrane dimensions directly affect any resonance frequencies. The first graph shows four peaks, each indicating a resonance frequency. A first resonance frequency is for the first and the second graph about the same: 1.58 MHz. The first graph shows further resonance frequencies at 1.73 MHz, 2.10 MHz and 2.72 MHz. The second graph shows further resonance frequencies at 1.76 MHz, 2.22 MHz and 2.98 MHz. These resonance frequencies allow to determine the actuator compliance. As the actuator properties define the resonance frequencies, taking other parameters of the actuator design as having a predetermined value, it is enabled to determine the actuator compliance from the resonance frequencies. Such method, of course, is only feasible if it is presumed that the other actuator properties have an actual value that is close to the presumed value. In another embodiment, it is considered to determine a value of one or more of such other actuator properties. In yet another embodiment, it is considered to employ a more detailed mathematical model that allows to determine a value for multiple parameters based on the results of the impedance spectrum. In accordance with common mathematical theory, there may be derived a value for as many parameters as there are independent input values. Whether it is actually feasible to derive a usable value for multiple parameters based on a determined number of independent resonance frequencies is however dependent on more aspects than mathematical theory only. For example, a relatively high noise level may result in such low accuracy that certain obtained values would not be useful.

Defining and considering a suitable mathematical model for the inkjet print head acoustics and related calculations for deriving values of certain parameters from an impedance spectrum is deemed to be within the ambit of the person skilled in the art and is not further elucidated here.

For more detailed discussion of properties and determining/measuring of such properties, reference is made to ANSI/IEEE Std 176-1987 and/or NEN-EN 50324-2:2002. For example, the former provides a mathematical equation describing the impedance spectrum based on properties of the piezo material. Based on the mathematical equation, it appears that the actuator may be defined by three parameters and such three parameters are derivable from a measured impedance spectrum.

While detailed embodiments of the present invention are disclosed herein, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any advantageous combination of such claims are herewith disclosed.

Further, the terms and phrases used herein are not intended to be limiting; but rather, to provide an understandable description of the invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. Inkjet print head for expelling a droplet of a fluid through a nozzle orifice, the inkjet print head comprising
a fluid channel for holding a channel amount of fluid, the fluid channel comprising a pressure chamber in fluid communication with the nozzle orifice;
a piezo actuator comprising
an active piezo stack, comprising a first electrode, a second electrode, and a piezo-material layer arranged between the first and the second electrode;
a membrane having a first side and a second side, the second side being opposite to the first side, wherein the active piezo stack is provided at the first side and the pressure chamber at the second side such that the membrane forms a flexible wall of the pressure chamber;
wherein
the piezo actuator has an actuator compliance;
the fluid channel, when holding the channel amount of fluid, has a fluid channel compliance,
the fluid channel compliance and the actuator compliance together form a total system compliance which corresponds to all compliances of the inkjet print head, and
the actuator compliance is larger than the fluid channel compliance.

2. The inkjet print head according to claim 1, wherein the actuator compliance is more than twice the fluid channel compliance and preferably more than five times the fluid channel compliance.

3. Method of designing an piezo-actuated inkjet print head, the method comprising
selecting an acoustic design, the acoustic design including an unloaded volume displacement of the piezo actuator in response to a drive voltage and a total system compliance, which corresponds to all compliances of the inkjet print head;
selecting an actuator compliance and a fluid channel compliance, the actuator compliance corresponding to a compliance of the piezo actuator and the fluid channel compliance corresponding to a compliance of a fluid channel, when holding a channel amount of fluid, the actuator compliance and the fluid channel compliance together forming the total system compliance;
wherein the actuator compliance is selected to be larger than the fluid channel compliance; preferably the actuator compliance is selected to be more than twice the fluid channel compliance and more preferably to be more than five times the fluid channel compliance.

4. Method of manufacturing a piezo-actuated print head having been designed to have a desired actuator compliance, wherein the method comprises the steps of
manufacturing at least a part of an piezo-actuated inkjet print head according to claim 1, wherein said part at least includes the piezo-actuator, the piezo-actuator comprising
an active piezo stack, comprising a first electrode, a second electrode, and a piezo-material layer arranged between the first and the second electrode;
a membrane, the active piezo stack being provided on a first side of the membrane;
performing impedance spectroscopy on the part of the piezo-actuated inkjet print head to obtain an impedance spectrum;
deriving from the impedance spectrum an actual actuator compliance; and
comparing the actual actuator compliance with the desired actuator compliance.
